(19) United States
(12) Patent Application Publication
(10) Pub. No.: US 2016/0282596 A1
(43) Pub. Date: Sep. 29, 2016

(54) IMMERSION MICROSCOPE OIL DISPENSER

(71) Applicant: CLEMEX TECHNOLOGIES INC., Longueuil (CA)

(72) Inventors: Cristian CIOBOTA, Longueuil (CA); Roch TOURIGNY, Longueuil (CA); Clément FORGET, Boucherville (CA)

(21) Appl. No.: 14/442,612

(22) PCT Filed: Nov. 12, 2013
(86) PCT No.: PCT/CA2013/000956

§ 371 Date: May 13, 2015

Related U.S. Application Data
(60) Provisional application No. 61/725,686, filed on Nov. 13, 2012.

(51) Int. Cl. G02B 21/33; G02B 21/00; G02B 21/34; G02B 21/36; G02B 7/16; G02B 21/26

(52) U.S. Cl. CPC G02B 21/33; G02B 7/16; G02B 21/26; G02B 21/34; G02B 21/365; G02B 21/002

(57) ABSTRACT

A microscope system has a rotatable turret having objective ports for receiving lens objectives. A liquid dispenser is received in one of the objective ports and is rotatable with the rotation of the turret. The liquid dispenser further has a nozzle for dispensing liquid and an inlet in communication with the nozzle. A liquid supply system supplies liquid to the liquid dispenser from a reservoir located remote of the turret. The turret can be rotated free of a force being exerted on it from the liquid dispenser and the liquid supply system. In use, an area of interest of a slide is identified and the turret is rotated so that the objective port having the liquid dispenser is selected as the active objective port. The liquid supply system is controlled so that liquid is dispensed onto the area of interest of the slide. The turret is further controlled to position a higher magnification immersion objective above the area of interest and to contact the dispensed liquid.

### FIELD

The present subject-matter relates to microscope systems, and more particularly to automated liquid immersion microscopes.

### INTRODUCTION

Magnifying systems such as microscopy systems are commonly used for conducting research, quantitative characterization and screening in various applications, such as semi-conductors fabrication, pharmaceutical research, biomedical and biotechnology laboratories, aerospace and automotive parts manufacturing. The measurements of attributes characterizing the elements present in microscopic images, finds applications in materials science and in pharmaceutical and biotechnological research.

Liquid immersion microscopy is a technique used to increase the resolution of a microscope system by providing a layer of liquid between a specimen to be viewed and an objective lens. The liquid may be water, but is more typically cedar oil or a specially-formulated synthetic immersion oil. The immersion liquid has a higher index of refraction than air, preferably close to that of glass, so there is a lower dispersion of light rays, which results in an increase of the resolution of the microscope system.

Traditional methods of liquid immersion require a human operator to manually dispense the liquid, for example using an elongated pipette, between the slide and the objective lens for each slide to be examined. This technique is tedious and time-consuming. Some automated dispensing techniques have therefore been explored.

U.S. publication no. 2006/0291041 describes a microscope fluid applicator that includes an immersion fluid reservoir for storing immersion fluid and an applicator tip coupled to the immersion fluid reservoir. The microscope fluid applicator is releasably engaged to a moveable turret on a microscope. The microscope fluid applicator may be secured to an objective lens port on a turret of a microscope via threads. Immersion fluid is ejected from the applicator tip onto a sample holder. The turret may be rotated to place an immersion fluid objective into the immersion fluid. The sample may then be viewed through the immersion fluid. Any excess immersion fluid that is dispensed from the applicator tip may be collected in a fluid collector to prevent contamination of the microscope optics and other components.

U.S. publication 2008/0259327 describes a device for inspecting, measuring defined structures, simulating structures and structural defects, repair of structures, and post-inspecting defined object sites on a microscopic component with an immersion objective. The device comprises a stage that is movable in the x-coordinate direction and in the y-coordinate direction and a holder for the microscopic component, whereby the holder is placed on the stage with the microscopic component in it. The holder has a reservoir with immersion or cleaning fluid, respectively. The stage is movable such that the immersion objective is located directly above the reservoir and may dip into the fluid with its front-most lens.

### SUMMARY

It would thus be highly desirable to be provided with a system or method that would at least partially address the disadvantages of the existing technologies.

According to one aspect of the present subject matter, there is provided a microscope system that includes: a turret having a plurality of objective ports for receiving lens objectives, the turret being rotatable about an axis of rotation; a liquid dispenser received in one of the objective ports and being rotatable with rotation of the turret, the liquid dispenser having a nozzle for dispensing liquid and an inlet in fluid communication with the nozzle; a liquid supply system coupled to the liquid dispenser, the liquid supply system supplying liquid from a liquid reservoir located remote of the turret to the inlet of the liquid dispenser; wherein the turret is rotatable substantially free of a force exerted thereon from the liquid dispenser and the liquid supply system. According to various exemplary embodiments, the microscope further includes a processor for controlling various components of the microscope to carry out an automated sample analysis process that includes controlling the turret to select the objective port having the liquid dispenser mounted thereon as the active objective port and dispensing an effective amount of liquid on the slide in order to provide higher resolution images.

According to another aspect, there is provided a method for automatically analyzing a sample using a microscope, including the steps of providing a sample on a slide; loading the slide on the stage of the microscope; identifying an area of interest of the sample using a lower magnification dry objective of the microscope; automatically displacing the stage to align the area of interest with a nozzle of the liquid dispenser of the microscope; dispensing through the nozzle of the liquid dispenser an effective amount of liquid to an area of the slide corresponding to the area of interest of the sample; and automatically positioning a higher magnification objective above the area of interest to cause a lens of the objective to contact the amount of liquid on the slide.

According to another aspect, there is provided an articulated liquid dispenser assembly for a microscope comprising: a liquid dispenser having a nozzle and a mounting member for coupling the liquid dispensing part to the rotatable turret of the microscope, the liquid dispensing part further having an inlet in fluid communication with the nozzle; a liquid conveying part having an outlet and an inlet for receiving a source of liquid to be dispensed; and a connector rotatably coupling the liquid dispensing part to the liquid conveying part and providing fluid communication between the outlet of the liquid conveying part and the inlet of the liquid dispensing part; and a support to hold the dispenser so that the rotational axis of the connector is substantially aligned with the rotational axis of the turret.

### DRAWINGS

The following drawings represent non-limitative examples in which:

FIG. 1 is an side elevation view of a microscope system according to various exemplary embodiments;

FIG. 2 is an isometric view of a liquid dispensing part according to various exemplary embodiments;

FIG. 3 is a section view of the liquid dispensing part along the line A-A according to various exemplary embodiments;

FIG. 4 is an isometric view of the liquid conveying part according to various exemplary embodiments;

FIG. 5 is a section view of the liquid conveying part along the lines B-B according to various exemplary embodiments;

FIG. 6 is an isometric view of the liquid dispenser according to various exemplary embodiments;

FIG. 7 is an side elevation side view of the liquid dispenser according to various exemplary embodiments;

FIG. 8 is an section view of the liquid dispenser according to various exemplary embodiments;

FIG. 9 is an isometric view of a connector of the liquid dispenser according to various exemplary embodiments;

FIG. 10 is a top plan view of the connector of the liquid dispenser according to various exemplary embodiments;

FIG. 11 is a section view of the connector of the liquid dispenser along the lines C-C according to various exemplary embodiments; and

FIG. 12 is an isometric view of a bracket of the liquid dispenser according to various exemplary embodiments.

FIG. 13 is a schematic diagram of a method for automated sample analysis according to various exemplary embodiments.

### DESCRIPTION OF VARIOUS EMBODIMENTS

The following examples are presented in a non-limiting manner.

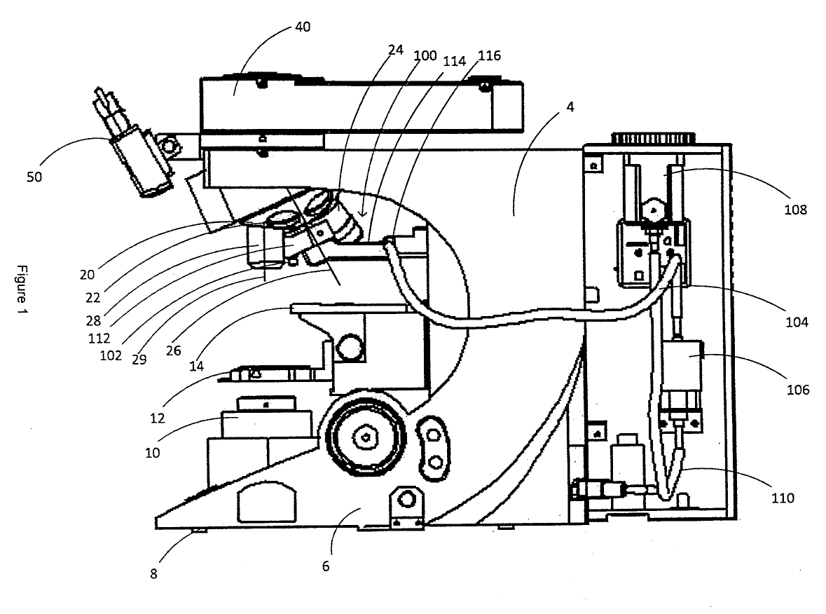

Referring to FIG. 1, therein illustrated is a side elevation view of an automated microscope system 2 according to various exemplary embodiments. The microscope system 2 includes a body 4, having a base 6 defining an underlying horizontal surface 8. The microscope system 2 further includes a light source 10 for illuminating a sample to be analyzed, a diaphragm 12 for modulating the amount of light from the light source 10 that is shone upon the sample, and a stage 14 for holding a slide that further holds the sample to be analyzed. The stage 14 is movable in a horizontal plane substantially parallel to the underlying horizontal surface 8. The stage 14 can also be moved vertically to adjust its height with respect to the underlying surface 8 of the base 6.

The microscope system 2 further comprises a turret 20 having a plurality of objective ports 22 for receiving objective lenses 24. The turret 20 is rotatable about an axis of rotation 26 to allow selection of an active objective port 28. For example, the objective ports 22 of the turret 20 can be arranged circularly around the axis of rotation 26. For example, as shown in FIG. 1, the objective ports 22 can be angled outwardly from the axis of rotation 26, which minimizes the diameter of the turret 20 while allowing for a larger number of objective ports 22. The active objective port 28 corresponds to the objective port 22 that is positioned above the diaphragm 12 and light source 10. For example, the orientation of an objective lens 24 mounted in the active port is defined by vertical 29, which is substantially perpendicular to the underlying surface 8. It will appreciated that where an objective lens 24 is received within the active objective port 22, that objective lens 24 can be used to view and analyze the sample held in the stage 14.

According to various exemplary embodiments, an eyepiece is aligned with the active objective port 28 to allow viewing of the sample through the eyepiece and magnified by the objective lens 24.

According to various exemplary embodiments for a computerized microscope system 2, an imaging system 40 positioned above the turret 20 is used to view and/or analyze the sample magnified by the objective lens 24 in the active objective port 28. The imaging system 40 may include a camera, such as a CCD or CMOS camera, for obtaining digital images of the sample magnified by the objective lens 24.

According to various exemplary embodiments, the microscope system 2 further includes a slide identifier 50, which can be used to read a unique identifier of the slide being held in the stage 14. For example, each of the slides may include a bar code and the slide identifier 50 is a bar code reader. Advantageously, the slide identifier 50 allows for automatic identification of a slide. This is particularly useful where a batch of slides is being analyzed and each slide needs to be machine-identified.

The microscope system 2 includes a liquid dispenser 100 for dispensing liquid onto the slide 14. The liquid dispenser 100 includes a nozzle 102 for directing the dispensing of the liquid. The liquid dispenser 100 can be mounted onto one of the objective ports 22 of the microscope system 2. The liquid dispenser 100 includes a mounting member for coupling to one of the objective ports 22. Selecting the objective port 22 having the liquid dispenser 100 inserted therein as the active objective port 28 results in the nozzle 102 being positioned above the stage 14. Since the turret 20 is rotatable about its axis of rotation 26, this selection of the liquid dispenser 100 can be achieved by rotating the turret 20 as if an objective lens 24 was mounted to the same port 20.

According to various exemplary embodiments, the immersion liquid is a suitable liquid having an index of refraction that is higher than that of air to reduce dispersion of light rays. For example, the liquid may be water or it may be a type of natural or synthetic immersion oil.

The liquid dispenser 100 is connected to a liquid supply system, which connects the liquid dispenser 100 with a reservoir of the liquid to be dispensed. For example, liquid is supplied via an outlet of the liquid supply system to an inlet of the liquid dispenser 100. The inlet of the liquid dispenser 100 is further in fluid communication with the nozzle 102.

For example, the liquid supply system includes first tube 104, which connects to a pump 106. The pump 106 is further connected to a liquid reservoir 108, for example, by a second tube 110. While a first tube 104 and second tube 110 are shown in FIG. 1, it will be understood that other suitable means of channeling the liquid may be used, such as a piping system. The pump 106 can be any suitable type of pump for selectively feeding an amount of liquid from the liquid reservoir 108 to the liquid dispenser 100 such that liquid is dispensed from the nozzle 102. Where the liquid supply system and liquid dispenser 100 are primed, i.e. pre-filled with liquid, the feeding of the amount of liquid by the pump 106 results in the same amount of being dispensed from the nozzle 102. Advantageously, the pump 106 is a solenoid pump for feeding a precise predetermined amount of liquid each time that it is activated. The pump 106 can be selected to provide an amount of liquid in the range of approximately 35 μL to 100 μL. For example, the pump 106 can be selectively activated by an external control, such as control signals received from the processor of the microscope system 2. For example, suitable pump 106 is the SV Metering Pump from Valcor Scientific.

It will be appreciated that various components of the liquid supply system are located remote of a sample analysis region of the microscope system 2. The sample analysis region refers generally to the region surrounding the stage 14 where a sample to be analyzed is located, and includes the rotatable turret 20, the objectives lenses 24 mounted in objective ports 22, and the movable stage 14. Advantageously by locating various components of the liquid supply system remote of the sample analysis region, the choice of these components is not restricted by the space constraints presented by the sample analysis region. For example, a variety of suitable pumps 106 of different sizes can be used to feed an amount of liquid to the nozzle 102 of the liquid dispenser 100. The size of the liquid reservoir 108 is also not restricted by the space available in or near the sample analysis region and a remote liquid reservoir 108 having an adequate volume can be applied to the liquid supply system. Advantageously, this allows the dispensing of liquid to a large number of slides without having to refill the liquid reservoir 108, which is particularly useful for an automated process of analyzing large batches of slides.

However, despite the various components being remote, the liquid supply system connected to the liquid dispenser 100, for example via first tube 104, allows the nozzle 102 to be located within the sample analysis region and selectable as if it was one of the objective lens 24 of the microscope system 2.

According to various exemplary embodiments, the liquid can be dispensed onto the slide from nozzle 102 without the nozzle 102 contacting a slide being position in stage 14. For example, nozzle 102 is positioned at a height above the slide while leaving a space between an end of the nozzle 102 and the slide. The pump 106 is then activated to cause liquid to be dispensed onto the slide from the nozzle 102 in a contactless manner. Fluid applicators that require contacting of the applicator with the slide can cause undesirable mechanical forces. For example, the contacting of the applicator with the slide can exert forces onto the turret, which can result in the objectives 24 mounted on the turret to fall out of alignment. Advantageously, by dispensing liquid from nozzle 102 without the nozzle 102 contacting the slide, mechanical forces exerted on the turret 20 by the liquid dispenser 100 are minimized, thereby allowing the turret 20 to be substantially free of a force exerted thereon from the liquid dispenser 100 and the liquid supply system.

According to various exemplary embodiments, the liquid dispenser 100 is coupled to the liquid supply system to be rotatable about the liquid supply system while ensuring fluid communication between the outlet of the liquid supply system with the inlet of the liquid dispenser 100. In particular, the liquid dispenser 100 rotates about the liquid supply system when the turret 20 is rotated. A suitable connection is used to rotatably couple the liquid dispenser 100 to the liquid dispensing system such that minimal mechanical force is exerted upon the turret 20 when the rotation of the turret 20 causes the liquid dispenser 100 to rotate about the liquid supply system. The liquid dispenser 100 is advantageously coupled to the liquid supply system to have an axis of rotation that is substantially aligned with the axis of rotation 26 of the turret 20. It will be appreciated that due to this alignment of the axes, there is minimal radial or axial forces being exerted by the liquid dispenser 100 or the liquid supply system. Therefore, the turret 20 is rotatable free of a force exerted on it from the liquid dispenser 100 and liquid supply system.

According to various exemplary embodiments, the liquid dispenser 100 is articulated and formed of at least a liquid dispensing part 112 and a liquid conveying part 114. The liquid dispensing part 112 includes the nozzle 102 of the liquid dispenser 100 and a mounting member. The liquid conveying part 114 includes the inlet of the liquid dispenser 100. According to the articulated liquid dispenser 100, the inlet of the liquid dispenser remains in fluid communication with the nozzle 102. The inlet on the liquid conveying part 114 connects to an outlet of the liquid supply system. For example, the inlet on the liquid conveying part 114 is located at an end region and is connected to an end 116 of the first tube 104 of the liquid supply system. The liquid dispensing part 112 is rotataby coupled to the liquid conveying part 114 such that the articulated liquid dispenser 100 is rotatable with the rotation of the turret 20. In particular, the liquid dispensing part 112 has an axis of rotation corresponding to the location of the coupling with the liquid conveying part 114. The axis of rotation of the liquid dispenser 100 is thus aligned with the axis of rotation 26 of the turret 20. In particular, the axis of rotation of the liquid dispensing part 112 about the liquid conveying part 114 is aligned with the axis of rotation 26 of the turret 20. It will be appreciated that due to this alignment of the axes, there are minimal radial or axial forces exerted by the liquid dispensing part 112 and liquid conveying 114 on the turret 20. Therefore, the turret 20 is rotatable free of a force exerted on it from the articulated liquid dispenser 100 and liquid supply system.

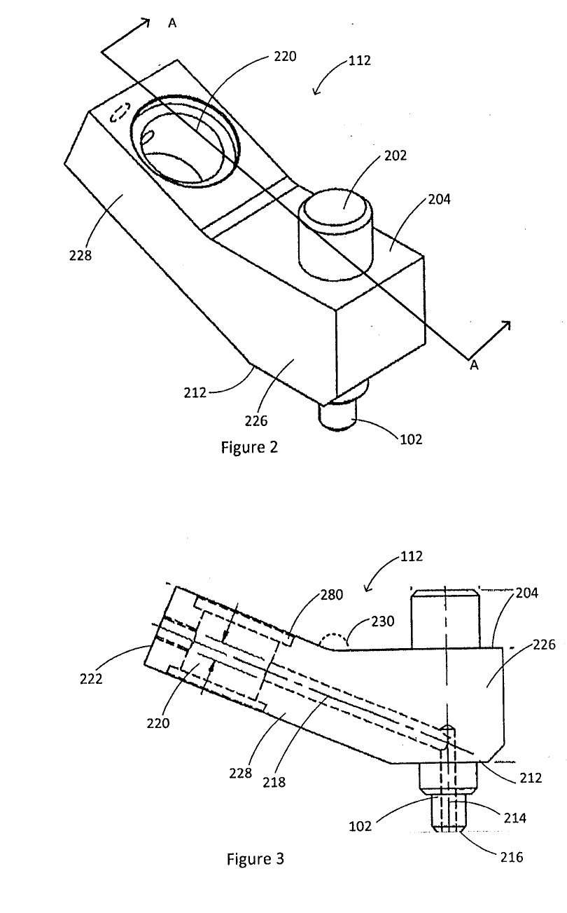

Referring now to FIGS. 2 and 3, therein illustrated is an isometric view and section view of the liquid dispensing part 112 of the articulated liquid dispenser 100 according to various exemplary embodiments. The liquid dispensing part 112 has a mounting member 202 for mounting the liquid dispensing part 112 into an objective port 22 of the turret 20. For example, the mounting member 202 can be cylindrical and extend from a first surface 204 of the liquid dispensing part 112. The nozzle 102 extends from a second surface 212 of the liquid dispending part 100 opposite the first surface 204. A nozzle bore 214 of the nozzle 102 extends a portion of the distance between the tip 216 of the nozzle 102 and the first surface 204. The nozzle bore 214 is in fluid communication with an elongated inner bore 218, which is further in fluid communication with an inlet 220 of the liquid dispensing part. The elongated inner bore 218 can be formed by boring from an end 222 of the liquid dispensing part 112 along the length of the liquid dispensing part 112 towards an end of the nozzle bore 214. A plug 224 is further provided to seal the opening of the elongated inner bore 218 at the end 222 of the liquid dispensing part 112.

According to various exemplary embodiments, the liquid dispensing part 112 includes two portions being in an angled arrangement relative to one another. A first portion 226 is arranged perpendicularly to the mounting member 202 and nozzle 102 such that the first portion 226 is substantially horizontal with respect to an underlying surface of the microscope system 102 when the liquid dispensing part 112 is inserted into an active objective port 28 of the turret 20. A second portion 228 extends at an angle from the first portion 226 to be substantially perpendicular with the axis of rotation 26 of the turret 20. The angle 230 formed by the first and second portions 226, 228 is the supplement of the angle between the axis of rotation 26 of the turret 20 and the vertical 29 defining the active objective port 28. The elongated inner bore 218 extends through the first portion 226 and the second portion 228. Furthermore, the inlet 220 of the liquid dispensing part 112 is located in the second portion 228 and can be a cylindrical throughbore extending from the first surface 204 to the second surface 212. For example, an axis of the cylindrical inlet 220 is aligned with the axis of rotation 26 of the turret 20 when the liquid dispensing part 102 is inserted into the active objective port 28 of the turret 20. For example, the liquid dispensing part 112 is made of a suitable aluminum alloy.

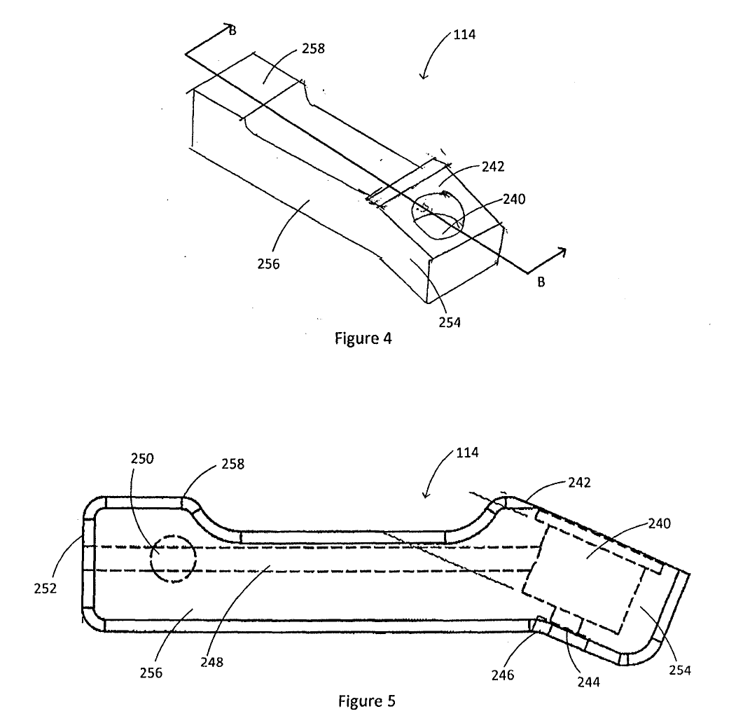

Referring now to FIGS. 4 and 5 simultaneously, therein illustrated are an isometric view and section view respectively of the liquid conveying part 114 according to various exemplary embodiments. The liquid conveying part 114 includes an outlet 240, which may be a cylindrical recess in the first surface 242. For example, the outlet cylindrical recess can be formed by boring from the first surface 242 of the liquid conveying part 114. A bottom of the cylindrical recess outlet 240 can be further bored to define an opening 244 in the bottom surface 246 of the liquid conveying part 114. The outlet 240 is in fluid communication with an elongated inner bore 248 of the liquid conveying part, which is further in fluid communication with an inlet 250 of the liquid conveying part 114. The elongated inner bore 248 can be formed by boring from an end 252 of the liquid conveying part 114 along the length of the liquid conveying part 114 towards the location of the outlet 240. The inlet 250 is defined by a hollow extension extending laterally from a side wall 253 of the liquid conveying part 114. The liquid conveying part may be further bored laterally from the side wall 253 to form a lateral bore in communication with the elongated inner bore 248.

According to various exemplary embodiments, the liquid conveying part 114 is formed of two portions being in an angled arrangement relative to one another. A first portion 254 extends at angle from the second portion 256. The outlet 240 is located in the first portion 254 with the axis of the cylindrical recess being substantially perpendicularly to the plane defined by the first surface 242 of the first portion 254. The elongated inner bore 248 extends from the end 252 of the second portion 256 through the first portion 254 to be in fluid communication with outlet 240. For example, the liquid conveying part 114 is made of a suitable aluminum alloy.

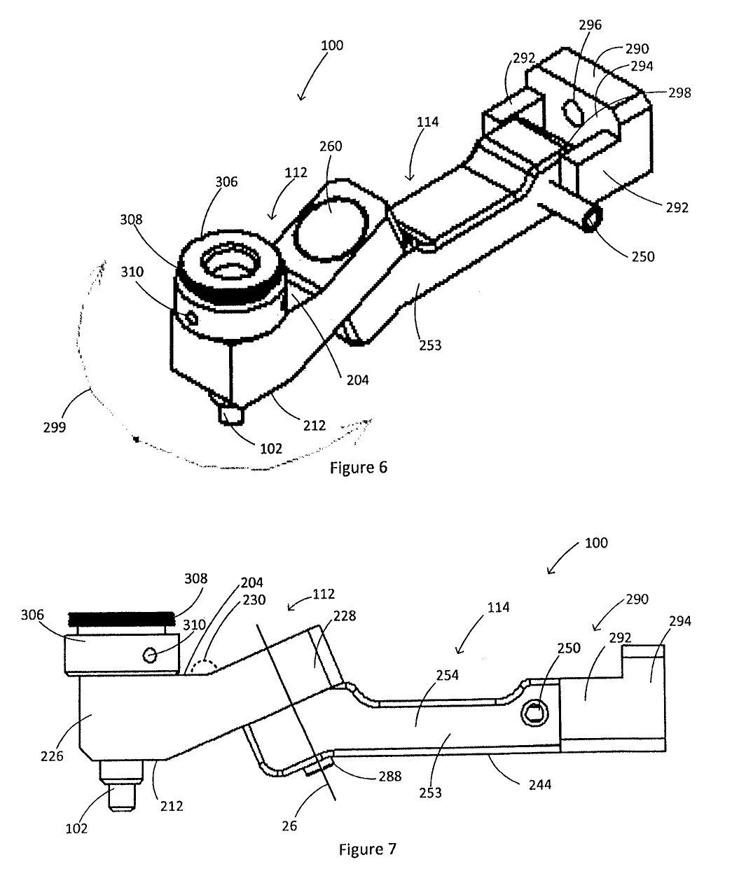

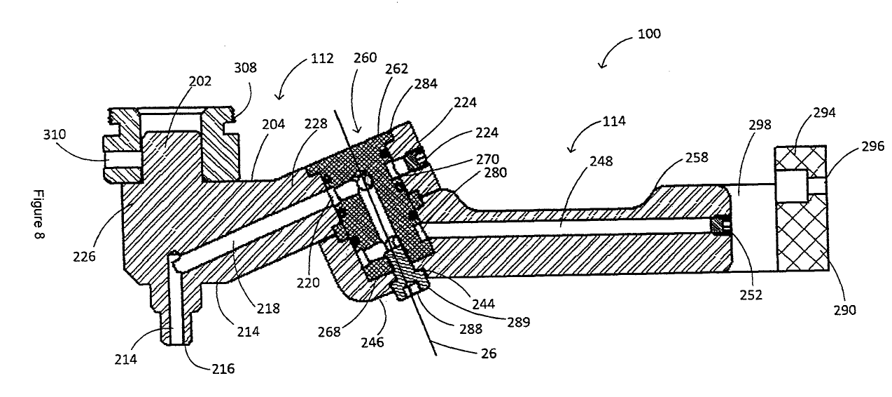

Referring now to FIGS. 6, 7, and 8 simultaneously, therein illustrated are an isometric view, a side elevation view, and sectional view, respectively, of the liquid dispenser 100 according to various exemplary embodiments. The second portion 228 of the liquid dispensing part 112 is coupled to the first portion 254 of the liquid conveying part 114 such that cylindrical inlet 220 of the liquid dispensing part 112 is aligned with cylindrical recess outlet 240 of the liquid conveying part 114. A suitable connector 260 rotatably couples the liquid dispensing part 112 to the liquid conveying part 114 while providing fluid communication between the outlet 240 of the liquid conveying part 114 and the inlet 220 of the liquid dispensing part 112.

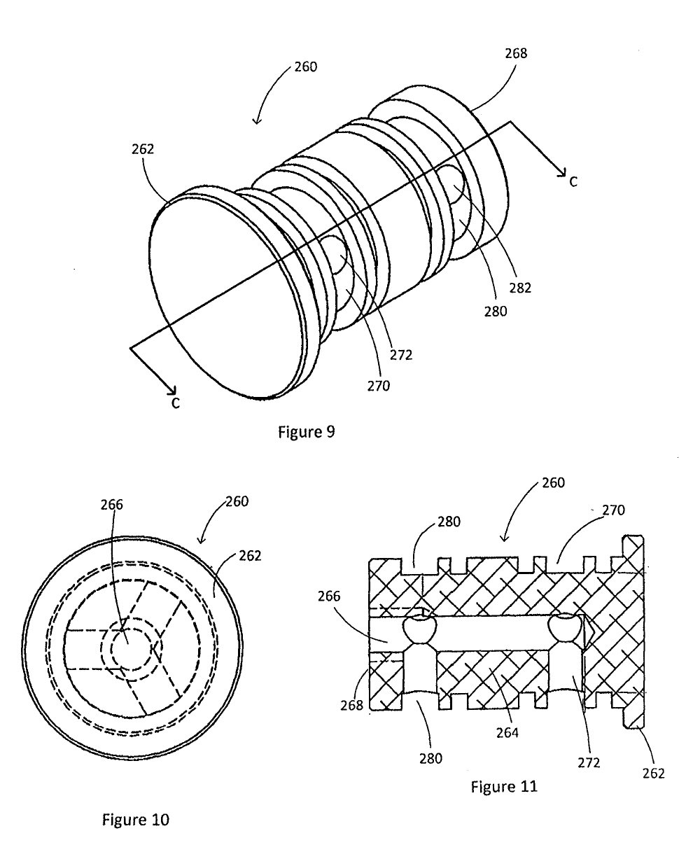

Referring now to FIGS. 9, 10, and 11, therein illustrated are an isometric view, a top plan view and a section view along the lines C-C respectively of the connector 260 according to various exemplary embodiments. The connector 260 includes a flange 262 extending circumferentially from a body of the connector 260. The connector 260 further includes an inner bore 266 extending along a portion of its length. The inner bore extends from an end 268 opposite the flange 262 to a location intermediate the length of the connector 260. The connector 260 includes a first circumferential groove 270 extending around the circumference of the body of the connector 260 at a first location along the length of the connector 260. A first set of radial bores 272 are further defined in the body of the connector 260. The first set of radial bores 272 is positioned at the location corresponding to first circumferential groove 270. Each of the first set of radial bores 272 extends radially from an outer surface of the connector 260 to the inner bore 266, thereby providing fluid communication between the first circumferential groove 270 and the inner bore 266. According to the illustrated example, the first set of radial bores 272 has three bores being arranged at an equal angular distance from one another.

The connector 260 further includes a second circumferential groove 280 extending around the circumference of the body of the connector 260 at a second location along the length of the connector 260. A second set of radial bores 282 are further defined in the body of the connector 260. The second set of radial bores 282 is positioned at the location corresponding to the second circumferential groove 280. Each of the second set of radial bores 282 extend radially from an outer surface of the connector 260 to the inner bore 266, thereby providing fluid communication between the second circumferential groove 280 and the inner bore 266. According to the illustrated example, the second set of radial bores 282 has three bores being arranged at an equal angular distance from one another.

Referring back to FIGS. 6, 7, and 8, the connector 260 is shown coupling the liquid dispensing part 112 to the liquid conveying part 114. The connector 260 extends from the first surface 242 of the liquid dispensing part 112 through the cylindrical throughbore inlet 220 and into the cylindrical recess outlet 240. The flange 262 of the connector 260 is disposed against a recessed lip 284 of the cylindrical inlet 220 and restrains the liquid dispensing part 112 from separating from the liquid conveying part 114. A sealing plug 288 projects through the opening 244 on the bottom surface 246 of the liquid conveying part 114 and extends into the inner bore 266 of the connector 260. The sealing plug 288 sealably and fixedly engages the connector 260. The sealing plug 288 further includes an outer flange 289, which is disposed against the bottom surface 246 surrounding the opening 244 to restrain the liquid conveying part 114 from separating from the liquid dispensing part 112.

According to various exemplary embodiments wherein the connector 260 rotatably couples the liquid dispensing part 112 to the liquid conveying part 114, the connector 260 acts as the joint providing articulating motion to the liquid dispenser 100, as indicated by curved arrows 299. The liquid dispensing part 112 rotates about the portion of the connector 260 extending through the cylindrical inlet 220. The liquid conveying part 114 allows rotation of the portion of the connector 260 extending into the cylindrical recess outlet 240. Thus, where the liquid conveying part 114 is maintained at a fixed orientation, the cylindrical connector 260 rotates within the cylindrical recess outlet 240. In particular, the rotational coupling provided by the connector 260 allows the liquid dispensing part 112 to rotate circumferentially about the liquid conveying part 114 while exerting minimal forces in other directions, such as radially or axially.

In addition to rotatably coupling the liquid dispensing part 112 to liquid conveying part 114, the connector 260 further provides fluid communication between the outlet 240 of the liquid conveying part 114 and the inlet 220 of the liquid dispensing part 112. When coupling liquid dispensing part 112 and liquid conveying part 114, the first circumferential groove 270 of the connector 260 is in communication with the space defined by the cylindrical inlet 220 of the liquid dispensing part 112. Advantageously, the location of the first circumferential groove 270 along the length of the connector 260 corresponds to a location where the elongated inner bore 218 of the liquid dispensing part 112 contacts the cylindrical inlet 220. Similarly, when coupling the liquid dispensing part 112 and liquid conveying part 114, the second circumferential groove 280 of the connector 260 is in fluid communication with the space defined by the cylindrical recess outlet 240 of the liquid conveying part 114. Advantageously, the location of the second circumferential groove 280 along the length of the connector 260 corresponds to a location wherein the elongated inner bore 248 contacts the cylindrical recess outlet 240.

Accordingly, liquid being fed through the tube 104 from the pump 106 enters the inlet 250 of the liquid conveying part 114 to reach the elongated inner bore 248. From the elongated inner bore 248 of the liquid conveying part 114, the liquid then enters the outlet 240 and the second circumferential groove 280 of the connector 260. The liquid then enters one or more of the radial bores of the second set of radial bores 282 to reach the inner bore 266 of the connector 260. The liquid exits the inner bore 266 via one or more of the radial bores 272 of the first set of radial bores to reach the first circumferential groove 270 and inlet 220 of the liquid dispensing part 112. From the inlet 220 of the liquid dispensing part 112, the liquid enters the elongated inner bore 218 and reaches the nozzle bore 214 to be finally dispensed from the nozzle 102 of the liquid dispensing part 112.

While the examples illustrated herein show the diameter of the cylindrical inlet 220 being substantially equal to the diameter of the cylindrical recess outlet 240, it will be understood that the diameters can be different. For example, the diameter of the cylindrical inlet 220 may be greater than the diameter of cylindrical recess outlet 240, in which case the connector 260 will be in two parts, a first part extending through the cylindrical inlet 220 and having a diameter substantially equal to the diameter of the cylindrical inlet 220, and a second part extending into the cylindrical recess outlet 240 and having a diameter substantially equal to the diameter of the cylindrical recess outlet 240.

Continuing with FIGS. 6, 7 and 8, according to various exemplary embodiments, the mounting member 202 can be further coupled to an adaptor mount 306 for mounting into an objective port 22 of the microscope system 2. The adaptor mount 306 has an outer diameter corresponding to the diameter of the objective port 22, and may further include outer threads 308 for engaging inner threads of objective port 22. The adapter mount 306 is hollow and has an inner diameter corresponding to the diameter of the mounting member 202 of the liquid dispenser 100. The mounting member 202 can be inserted into the hollow interior of the adaptor mount 306. The adaptor mount 306 may further have one or more lateral openings 310 for engaging the mounting member 202 such that the mounting member 202 can be secured to the adaptor mount 306. The lateral opening 310 allows the mounting member 202 to be secured to the adaptor mount 306 without application of a screwing or rotational action to the liquid dispenser 100.

Referring back to FIG. 1, the exemplary articulated liquid dispenser 100 is shown being assembled to the microscope system 2. The mounting member 202 of the first portion 226 of liquid dispensing part 112 is coupled to one of the objective ports 22 of the turret 20. The second portion 228 of the liquid dispensing part 112 extends at an angle from the first portion 226 such that it is coupled to the liquid conveying part 114 to rotate about the axis of rotation 26 of the turret 20. The second portion 228 extends at an angle perpendicular to the axis of rotation 26. The first portion 254 of the liquid conveying part 114 is coupled to the second portion 228 of the liquid dispensing part 112 at the axis of rotation 26. The coupling provided by the connector 260 substantially aligns the axis of rotation of the liquid dispensing part 112 about the liquid conveying part 114 with the axis of rotation 26 of turret 20. The exemplary configuration of the liquid dispenser 100 allows it to rotate with the rotation of the turret 20 while reducing the mechanical forces exerted by the liquid dispenser 100 onto the turret 20, thereby allowing the turret 20 to be rotated substantially free of a force exerted thereon from the liquid dispenser 100 and the liquid supply system.

The liquid conveying part 114 provides a fluid connection between the inlet 220 of the liquid dispensing part 112 and the tube 104 of the liquid supply system. The liquid conveying part 114 has the effect of moving the attachment with the tube 104 of the liquid supply system away from the general area of the microscope system 2 used for examining the sample. For example, the liquid conveying part 114 moves the tube 104 away from the rotating turret 20, the objective lenses 24 inserted in objective ports 22 and the movable stage 14, so as to not interfere with the operation of the microscope system 2. While the liquid conveying part 114 is shown to be coupled to the tube 104 at a position near the body 4 of the microscope 2, it will be understood that other suitable locations for the attachment are possible as long as the tube 104 is moved away from other moving components of the microscope system 2. Preferably, the tube 104 is located away from the sample analysis area of the microscope system 2.

According to some exemplary embodiments, the second portion 256 of the liquid conveying part 114 extends at an angle from its first portion 254 to be substantially horizontal with the underlying surface 8 of the base. For example, the first surface 258 of the second portion 256 of the liquid conveying part 114 is recessed intermediate the first portion 254 of the liquid conveying part 114 and end 252. The recessed surface 258 allows rotation of the objective lenses 24 inserted in objective ports 22 to be freely displaced with the rotation of turret 20 without interference from the liquid dispenser 100. For example, each of the elements mounted in objective ports 22, including objectives lenses 24 and the nozzle 102 can complete a full rotation about the axis of rotation 26. Thus, despite the mounting of the liquid dispenser 100, at least 4 additional objectives lenses 24 can still be mounted on the turret 20. According to some exemplary embodiments, objective lenses 24 up to a length of 45 mm can be mounted onto the turret 20.

While the liquid conveying part 114 has been described as having a substantially horizontal orientation, it will be understood that other orientations of the liquid conveying part 114 are possible as long as the alignment of the axis of rotation of the liquid dispensing part 112 is maintained with the axis of rotation 26 of the turret 20. For example, the liquid conveying part 114 can be angled at an incline towards the base 4 of the microscope system 2. Advantageously, the liquid conveying part 114 is oriented so as not to obstruct the rotation of the objective lenses 24 of the turret 20 and to move the location of the connection of the liquid dispenser 100 with the tube 104 away from the sample analysis area.

According to various exemplary embodiments, a bracket 290 engages the liquid conveying part 114 to maintain the position of the liquid conveying part 114. It will be appreciated that without maintaining the position of the liquid conveying part 114, it could be displaced with the rotation of the liquid dispensing part 112. The maintenance of the position of the liquid conveying part 114 further serves to maintain the alignment of the axis of rotation of the liquid dispensing part 112 with the axis of rotation 26 of the turret 20. However when the liquid dispensing part 112 is rotated about the liquid conveying part 114, it is possible that the liquid dispenser 100 will exert some mechanical force on the turret 20, for example, due to imprecisions introduced in the fabrication process or assembly of the various elements. Being a precision instrument, the microscope system 100 is sensitive to even slight mechanical disturbances, and small mechanical forces exerted on the turret 20 can cause some of the objectives to become misaligned, requiring realignment and/or recalibration of the microscope system 2. (Some high magnification objectives have a field of view on the micron scale, and even a slight shift can cause the field of view to be changed.) In order to minimize mechanical forces exerted by the liquid dispenser 100 on the turret 20, the bracket 290 may engage the liquid conveying part 114 while allowing it to move in some directions. The bracket 290 can maintain the position of the liquid conveying part 114 in a direction between the sides of the microscope system 2, for example, while allowing movement of the liquid conveying part 114 along a vertical direction and from a front to back direction of the microscope system 2. As shown in FIG. 1, the bracket 290 is attached to the body 4 of the microscope system 2 at substantially the same height as the liquid conveying part 114. However, according to other exemplary embodiments where the second portion 256 of the liquid conveying part 114 extends at a different angle, the bracket 290 can be coupled to any other suitable location on the microscope system 2.

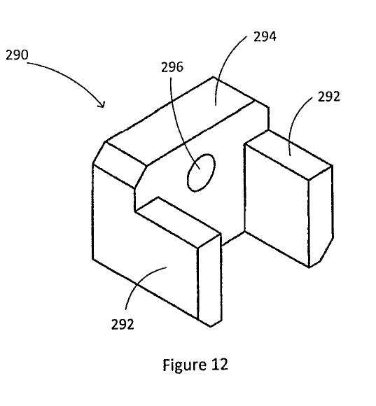

Referring now to FIG. 12, therein illustrated is an isometric view of the bracket 290 for engaging the liquid conveying part 114 according to various exemplary embodiments. The bracket 290 includes a pair of arms 292 extending from a bracket body 294. For example, the bracket body 294 defines an opening 296 for attachment of the bracket using for a suitable fastener.

Referring back to FIGS. 6, 7, and 8, the arms 292 of the bracket contact an end region of the second portion 256 of the liquid conveying part 114. For example, the arms 292 of the bracket 290 are spaced apart at a distance substantially equal to the width of the liquid conveying part 114. The liquid conveying part 114 is positioned between the arms 292 and its movement is restrained by the arms 292. The end 252 of the liquid conveying part 114 is positioned forward of a front face of the bracket body 294 to leave a space 298, allowing the liquid conveying part 114 to move towards and away from the bracket body 294. The liquid conveying part 114 can also move in a vertical direction parallel to the height of the bracket body 294. The engagement of the liquid conveying part 114 with the arms 292 of the bracket 290 allows it to be maintained in position in a side to side direction of the microscope system 2, thereby further maintaining the alignment of the axis of rotation of the liquid dispensing part 112 with the axis of rotation 26 of the turret 20. The free movement of the liquid conveying part 114 in the other two directions when engaging the bracket 290 minimizes mechanical forces exerted by the liquid dispenser on the turret 20.

According to various exemplary embodiments, one or more components of the microscope can be automatically controlled. For example, the stage 14 includes one or more motors that can be controlled to move the stage. Similarly, the light source 10 and diaphragm 12 also each include one or more motors that can be controlled. Moreover, the turret 20 also includes one or more motors that can be controlled to rotate the turret 20 to select a desired objective port 20 as the active objective port 28. Preferably each of the motors are electric motors that can be controlled by suitable microcontrollers emitting control signals. Furthermore, the pump 106 of the liquid conveying system can also be automatically controlled by a suitable microcontroller. For example, where the pump 106 is a solenoid pump, the microcontroller can emit electrical signals through the solenoid coil of the pump to activate the pump 106. The imaging system 240 can also be automatically controlled.

For example, each of the microcontrollers of the controllable components of can be can be implemented on a programmable processing device, such as a microprocessor or microcontroller, Central Processing Unit (CPU), Digital Signal Processor (DSP), Field Programmable Gate Array (FPGA), general purpose processor, and the like. In some embodiments, the programmable processing device can be coupled to program memory, which stores instructions used to program the programmable processing device. The program memory can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, and optical media.

According to various exemplary embodiments, the microscope system 2 is computerized and is adapted to carry out instructions for controlling various components of the microscope system. Preferably, the computerized microscope system 2 includes at least one programmable computer executing computer programs, each programmable computer comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, cellular telephone, smartphone, or tablet device. The programmable computer outputs control signals for controlling the various components of the microscope system 2. For example, the programmable computer outputs control signals for controlling the microcontrollers of each of the controllable components of the microscope system 2.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein.

It will be appreciated that according to some exemplary embodiments, the coupling of the liquid dispenser 100 to the turret 20 allows the liquid dispenser 100 and liquid supply system to be assembled to an existing microscope system. For example, where a microscope system previously required manual dispensing of liquid on the slide, the liquid dispenser 100 and liquid supply system can be retrofitted to the microscope system such that the microscope can perform automated slide analysis that includes automatic liquid dispensing. Where the liquid dispenser 100 is assembled to a newly fabricated microscope system, a significant redesign of the microscope system is not required in order to accommodate the liquid dispenser 100 and liquid supply system.

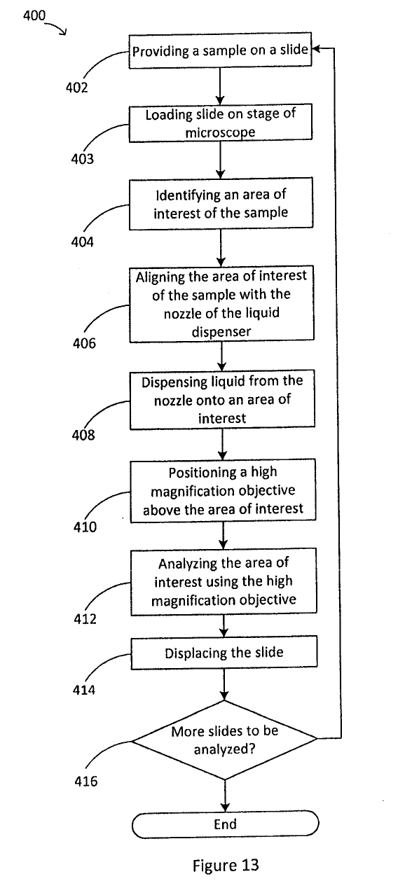

Referring now to FIG. 13, therein illustrated is a flowchart of a method 400 for automatically analyzing a sample using the microscope system 2. For example, the method can be carried out by the processor executing a plurality of instructions and controlling the components of the computerized microscope system 2.

At step 402, a sample to be analyzed is provided on a slide. For example, the sample is prepared by a lab technician and placed on the slide. Alternatively, the prepared slides are placed in an automatic stage loader.

At step 403, the slide is loaded onto the stage 14 of the microscope system 2. The slide can be automatically loaded onto the stage 14, for example upon receiving a command from the processor.

At step 404, an area of interest of the sample is identified. For example, a low magnification dry objective in the turret 20 can be selected by the processor as the active objective lens 24 by rotating the turret 20. Using the low magnification dry objective lens 24, images of various areas of the sample are captured and analyzed, for example using image analysis. For example, the processor can be configured to automatically carry out the image analysis for identifying areas of interest. For example, a large portion of the slide is analyzed to identify the area of interest.

The area of interest of the sample can be identified by incrementally moving the slide so that a plurality of sub-areas of the sample is scanned and analyzed using the first objective. Each of the sub-areas is analyzed, for example using computerized image analysis to identify one or more points of interest. An area of interest is then determined based on the identified one or more points of interest. For example, according to many applications, the points of interest are generally clustered in proximity of one another, and the area of interest corresponds to an average of the location of the points of interest.

At step 406, the area of interest of the sample is aligned with a nozzle for dispensing liquid onto the slide. For example, after using the low magnification dry objective lens 24 to identify areas of interest, the turret 20 is rotated to select the objective port 22 having the liquid dispenser 100 mounted thereon as the active objective port 28. Since a large portion of the slide may have been analyzed, the slide may be out of alignment. For example, the slide may have been moved to its edge. The slide is moved by controlling the stage 14 such that the area of interest identified at step 304 is aligned with the nozzle 102 of the liquid dispenser 100. For example, in addition to moving the slide in a horizontal plane, the height of the slide is adjusted by controlling the stage 14 to position the slide at an appropriate predetermined height from the nozzle tip 216. For example, the stage 14 can be automatically controlled by the processor of the microscope system 2. Since the nozzle 102 is mounted onto one of the objective ports 22, it occupies an area generally equivalent to an active objective lens when the nozzle 102 is selected as the active objective port 22. Therefore, the stage 14 only needs to be displaced a small distance in order to be aligned with the area of interest of the same in comparison to the distance required if the nozzle 102 was located remote from the turret 20. This provides a time saving during a process for automatically examining a large amount of slides.

At step 408, liquid is dispensed from the nozzle onto an area of the slide corresponding to the area of interest of the sample. The liquid is dispensed by activating the pump 106 connected to the liquid dispenser 100. The processor can control the activation of the pump 106. According to some exemplary embodiments, only an effective amount of liquid is dispensed from the nozzle. For example, the amount of liquid dispensed is between approximately 40 μL and approximately 90 μL, with a preferable amount of approximately 60 μL. The amount of liquid dispensed from the nozzle 102 is sufficient to cover the area on the slide corresponding to the area of interest of the sample identified at step 304. This area can correspond only to a fraction of the slide. Advantageously, by aligning the nozzle 102 with the area of interest and dispensing only a limited amount of liquid sufficient to cover the area of interest of the sample, an efficient use of liquid is achieved. This efficient use minimizes the frequency of refills of the liquid reservoir required, which minimizes downtime in an automated sample analysis process. Moreover, limiting the liquid dispensed to the area of interest instead of covering a larger portion of the slide with the liquid minimizes the risk of the liquid overflowing from the sides of the slide and dripping onto other microscope components. (Where the liquid is an immersion oil, overflown liquid can cause damage to the microscope components and cleaning of the overflown liquid can be difficult.) Limiting the liquid dispensed to a fraction of the surface of the slide also leaves a portion of surface remaining dry, which can be used for drying the objective lens 24, as described below.

At step 410, a high magnification immersion objective 24 is positioned by the processor above the area of interest of the sample to cause a lens of the objective to contact the amount of liquid dispensed on the slide. By filling the gap between the slide and the lens of the high magnification objective, the liquid reduces light dispersion, thereby contributing to a higher resolution image. For example, the high magnification objective is positioned by first controlling the turret 20 to be rotated to the objective port 22 holding the high magnification objective as the active objective port 28. The stage 14 may be further adjusted, for example, by moving the slide to a predetermined appropriate height so that the dispensed liquid contacts the high magnification immersion objective 24.

At step 412, the area of interest of the sample is analyzed by the processor using the high magnification immersion objective 24 according to known sample analysis techniques.

According to various exemplary embodiments, once the sample analysis technique is completed, at step 414, the slide is displaced so that the high magnification objective is displaced towards an area of the slide that is still dry. This causes the liquid contacting the lens of the high magnification immersion objective to be spread over the dry area of the slide. Due to surface tension, the liquid on the lens of the high magnification objective will be removed from the lens and spread onto the dry areas of the slide. For example, the slide is displaced by controlling the movable stage 14. Displacing the slide in this manner aids in removing some of the liquid from the lens of the objective.

According to various exemplary embodiments, in an automated process for analyzing a plurality of slides using the computerized microscope system 2, a determination is made at step 416 for whether there are any remaining slides to be analyzed. If there remains at least one slide to be analyzed, the method returns to step 402 and another slide is loaded onto the stage 14. If no more slides remain to be analyzed, the automated process is ended.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A microscope system comprising:
a turret having a plurality of objective ports for receiving lens objectives, the turret being rotatable about an axis of rotation;
a liquid dispenser received in one of the objective ports and being rotatable with rotation of the turret, the liquid dispenser having a nozzle for dispensing liquid and an inlet in fluid communication with the nozzle;
a liquid, supply system coupled to the liquid dispenser, the liquid supply system supplying liquid from a liquid reservoir located remote of the turret to the inlet of the liquid dispenser:
wherein the turret is rotatable substantially free of a force exerted thereon from the liquid dispenser and the liquid supply system.

2. The microscope system of claim 1, wherein an axis of rotation of the liquid dispenser is substantially aligned with the axis of rotation of the turret.

3. The microscope system of claim 2, further comprising a stage for receiving a slide, wherein the nozzle dispenses liquid onto the slide without contacting the slide.

4. The microscope system of claim 3, wherein the liquid supply system comprises a pump being connected to the liquid reservoir, the pump being adapted to selectively supply an amount of liquid from the liquid reservoir to the liquid dispenser to cause liquid to be dispensed from the nozzle.

5. The microscope system of claim 4, wherein the amount of liquid supplied by the pump is between approximately 40 μL and approximately 90 μL.

6. The microscope system of claim 5, wherein the liquid dispenser comprises:
a liquid dispensing part having the nozzle and a mounting member for coupling the liquid dispensing part to the turret;
a liquid conveying part having the inlet and being rotatably coupled to the liquid dispensing part to define an axis of rotation of the liquid dispenser; and
a bracket coupled to a body of the microscope system and engaging the liquid conveying part to maintain the liquid conveying part at a substantially fixed position in at least one direction.

7. The microscope system of claim 6, wherein the bracket comprises two extending arms spaced apart at a distance substantially equal to a width of the liquid conveying part for engaging a portion of the liquid conveying part and maintaining the liquid conveying part at a substantially fixed position in a direction corresponding to a side to side orientation of the microscope system while permitting vertical and longitudinal movement of the liquid conveying part.

8. The microscope system of claim 2, wherein the liquid dispenser comprises:
a liquid dispensing part having the nozzle and a mounting member for coupling the liquid dispensing part to the turret;
a liquid conveying part having an inlet and being rotatably coupled to the liquid dispensing part to define the axis of rotation of the liquid dispenser; and
a bracket coupled to a body of the microscope system and engaging the liquid conveying part to maintain the alignment of the axis of rotation of the liquid dispenser with the axis of rotation of the turret.

9. The microscope system of claim 6, wherein the liquid conveying part comprises:
a first portion rotatably coupled to liquid dispensing part; and
a second portion extending at an angle from the first portion, the second portion engaging the bracket and being positioned at a height to permit rotation of the turret having a plurality of objectives mounted thereon.

10. The microscope system of claim 9, further comprising:
a data storage for storing a plurality of instructions;
a processor coupled to the data storage, the processor configured for:
identifying an area of interest of a sample provided on a slide using a lower magnification dry objective;
controlling the turret to select the objective port having the liquid dispenser received therein as the active objective port;
controlling a stage having the slide mounted thereon to align the area of interest with the nozzle of the liquid dispenser;
controlling the liquid supply system to cause an effective amount of liquid to be dispensed through the nozzle to an area of the slide corresponding to the area of interest of the sample; and
controlling the turret to position a higher magnification immersion objective above the area of the interest of the sample and to cause a lens of the objective to contact the amount of liquid on the slide.

11. The microscope system of claim 10, wherein the processor is further configured for:
scanning a plurality of sub-areas of the sample with the low magnification dry objective;
identifying one or more points of interest using image analysis; and
determining an area of interest based on the identified one or more points of interest.

12. The microscope system of claim 11, wherein the effective amount of liquid dispensed is between approximately 40 μL and approximately 90 μL.

13. The microscope system of claim 12, wherein controlling the turret to select the objective port having the liquid dispenser comprises causing the turret to rotate to the objective port having the liquid dispenser received therein.

14. The microscope system of claim 13, wherein the processor is further configured for:
examining the area of interest of the sample using the higher magnification objective; and
controlling the stage to displace the slide to cause the liquid contacting the lens of the high magnification objective to be spread over a dry area of the slide.

15. The microscope system of claim 14, further comprising:
controlling the height of the stage to position the slide mounted thereon at a first predetermined distance away from the nozzle of the liquid dispensing part; and
controlling the height of the stage to position the slide mounted thereon at a second predetermined distance away from the lens of the higher magnification objective.

16. A method for automatically analyzing a sample using a microscope, the method comprising:
providing a sample on a slide;
loading the slide on the stage of a microscope;
identifying an area of interest of the sample using a lower magnification dry objective of the microscope;
automatically displacing the stage to align the area of interest with a nozzle of a liquid dispenser of the microscope;
dispensing through the nozzle of the liquid dispenser an effective amount of liquid to an area on the slide corresponding to the area of interest of the sample; and
automatically positioning a higher magnification immersion objective above the area of interest to cause a lens of the objective to contact the amount of liquid on the slide.

17. The method of claim 16, wherein identifying an area of interest of the sample using a first objective of the microscope comprises:
scanning a plurality of sub-areas of the sample with the lower magnification dry objective objective;
identifying one or more points of interest using image analysis; and
determining an area of interest based on the identified one or more points of interest.

18. (canceled)

19. (canceled)

20. (canceled)

21. (canceled)

22. (canceled)

23. An articulated liquid dispenser for a microscope comprising:
a liquid dispensing part having a nozzle and a mounting member for coupling the liquid dispensing part to the rotatable turret of the microscope, the liquid dispensing part further having an inlet in fluid communication with the nozzle;
a liquid conveying part having an outlet and an inlet for receiving a source of liquid to be dispensed;
a connector rotatably coupling the liquid dispensing part to the liquid conveying part and providing fluid communication between the outlet of the liquid conveying part and the inlet of the liquid dispensing part; and
a support to hold the dispenser so that the rotational axis of the connector is substantially aligned with the rotational axis of the turret.

24. The articulated liquid dispenser of claim 23, wherein the liquid dispensing part comprises:
a first portion, the mounting member extending from a first surface of the first portion and the nozzle extending from a second surface of the first portion and;
a second portion extending at an angle from the first portion, the inlet being defined in the second portion; and
an inner bore extending from the second portion to the first portion and providing fluid communication between the inlet and the nozzle.

25. (canceled)

26. (canceled)

27. (canceled)

28. (canceled)

29. (canceled)

30. The microscope system of claim 1, further comprising:
a data storage for storing a plurality of instructions;
a processor coupled to the data storage, the processor configured for identifying an area of interest of a sample provided on a slide using a lower magnification dry objective;
controlling the turret to select the objective port having the liquid dispenser received therein as the active objective port;
controlling a stage having the slide mounted thereon to align the area of interest with the nozzle of the liquid dispenser;
controlling the liquid supply system to cause an effective amount of liquid to be dispensed through the nozzle to an area of the slide corresponding to the area of interest of the sample; and
controlling the turret to position a higher magnification immersion objective above the area of the interest of the sample and to cause a lens of the objective to contact the amount of liquid on the slide.
